(19) United States
(12) Patent Application Publication
(10) Pub. No.: US 2009/0220923 A1
(43) Pub. Date: Sep. 3, 2009

(54) Tactile user interface and related devices

(76) Inventors: Ethan Smith, Pacifica, CA (US); Himanshu Jayant Sant, Salt Lake City, UT (US)

Correspondence Address: 212° Consulting, Inc., 851 Moraga Road, Bungalow B, Lafayette, CA, 94549, US

(21) Appl. No.: 12/316,495

(22) Filed: Dec. 12, 2008

Related U.S. Application Data
(60) Provisional application No. 61/008,029, filed on Dec. 18, 2007.

(51) Int. Cl. G09B 21/00

(52) U.S. Cl. 434/113

(57) ABSTRACT

An apparatus that includes an input having a surface area configured for altering its surface topology characteristic in accordance with a given function of an electronic device for providing a haptic operative input corresponding to said given function. There is a mechanism for altering surface topology of the surface area, and the mechanism does not comprise a piezoelectric motor.

This application claims priority to U.S. Provisional Patent Application No. 61/008,029 filed Dec. 18, 2007 (Docket No. TA-002-01) under 35 U.S.C. §119. Provisional application 61/008,029 is incorporated-by-reference into this document for all purposes.

### BACKGROUND OF THE INVENTION

1. Field of the Invention

This invention relates to tactile user interfaces, methods for actuating such interfaces and devices including such interfaces.

2. Description of the Related Art

A tactile display allows information to be communicated by stimulating a user's sense of touch. One method for communicating information in this way is by Braille. The user touches the Braille words, with the letters communicated through a series of bumps or dots. Refreshable Braille displays contain tactile devices for the blind and partially sighted, translating text from systems (e.g., computer) into readable characters. The display systems typically include two or more lines of Braille cells, each of which corresponds to a particular symbol (e.g., letter). Such systems are “refreshable” in that the display surface may be “wiped clean” and then can display another symbol. This allows for the sequential exhibition of different Braille letters.

The patent literature contains reports of several different methods that can be used to actuate, or form, a refreshable Braille cell. U.S. Pat. Publ. No. 20020106614, for instance, discusses a display system with a flexible surface. The system typically includes: a) a plurality of microelectromechanical valves having a top surface and a bottom surface; and b) an elastomeric polymer. In some forms, it uses piezoelectric devices or microelectromechanical shape memory alloy-actuated devices in place of the microelectromechanical valves.

A second application, U.S. Pat. Publ. No. 20040175676, takes a different approach. This application is directed to the hydraulic actuation of a Braille dot using the bending characteristics of electroactive polymers. The bending mechanism is transferred to the linear motion of the Braille dot according to the report.

### SUMMARY OF THE INVENTION

This invention relates to tactile user interfaces, methods for actuating such interfaces and devices including such interfaces.

In one aspect of the present invention, a method for actuating a Braille cell is provided. The method involves: providing power to a microheater within a cylinder, wherein the cylinder has a membrane at one end, and a heat expandable medium and further wherein the cylinder is divided into two separate sections, a first section and a second section; heating said heat expandable medium with said microheater, thereby causing it to expand; and bulging out said membrane under pressure from said expanding heat expandable medium, thereby forming a dot.

In another aspect of the present invention, a refreshable Braille cell is provided. The cell includes: a plurality of Braille cells arranged allow the user to touch the surface of the cells, each of said Braille cells comprising: a plurality of cylinder housings; a flexible membrane covering the openings at one end of the cylinder housings; and a mechanism for causing the flexible membrane at said respective one of said cylinders to bulge out to form a Braille dot; wherein the display is made using steps comprising conventional printed circuit board-based circuit manufacturing techniques.

In another aspect of the present invention, an apparatus is provided. The apparatus includes: an input having a surface area configured for altering its surface topology characteristic in accordance with a given function of an electronic device for providing a haptic operative input corresponding to said given function, wherein there is a mechanism for altering surface topology of the surface area, and wherein the mechanism does not comprise a piezoelectric motor.

In another aspect of the present invention, another apparatus is provided. The apparatus includes: an input having a surface area configured for altering its surface topology characteristic in accordance with a given function of an electronic device for providing a haptic operative input corresponding to said given function, wherein there is a mechanism for altering surface topology of the surface area, and wherein the mechanism comprises a cylinder or pin that moves in response to a medium that expands upon application of heat.

In another aspect of the present invention an input module is provided. The input module includes: a substrate having at least one defined contact surface in a deformable portion of said substrate; and, an actuator mechanism suitably arranged and configured for altering the surface topology of said substrate at said at least one defined contact surface area, wherein the mechanism comprises a cylinder or pin that moves in response to a medium that expands upon application of heat.

In another aspect of the present invention, another apparatus is provided. The apparatus includes: a mechanism to lock the pin in an actuated or resting state, where friction force is used to lock the pins in one position. The mechanism can lock the pins in both actuated and resting states. The mechanism can utilize any suitable force to include locking—e.g., electrostatic, mechanical, electromagnetic, etc. The mechanism can also be used to keep the pins in a locked position when the tactile interface is not in use.

### BRIEF DESCRIPTION OF THE FIGURES

FIG. 1 is a sectional view of one embodiment of an electrothermal cylinder according to the present invention that can be used in a refreshable tactile user interface cell.

FIG. 2 is a sectional view of two electrothermal cylinders in a refreshable tactile user interface cell.

FIG. 3a is a sectional view of three Braille cells in a line according to a previously described cylinder embodiment. See WO 2006/108121 and Pub. No. US 2007/0020589, both of which are herein incorporated by reference for all purposes.

FIG. 3b is a sectional view of two Braille cells arranged in two different lines according to a previously described cylinder embodiment. See WO 2006/108121, which is herein incorporated by reference for all purposes.

FIG. 4 shows a plan view of three refreshable tactile user interface cells according to the present invention actuated for the word “and” in Braille.

FIG. 5 shows one embodiment of a refreshable tactile user interface for a Braille computer screen according to the present invention.

FIG. 6 shows another embodiment of the refreshable tactile user interface according to the present invention;

FIG. 7 shows one embodiment of a method for presenting Braille text on a refreshable display according to the present invention.

FIG. 8 shows one embodiment of a Braille touch screen method according to the present invention.

FIG. 9 shows the architecture of Braille cell chambers according to the present invention. Sections I and II hold phase-change material with a heater at one end of Section I (not shown).

FIG. 10 also shows the architecture of Braille cell chambers according to the present invention. Sections I and II hold phase-change material. Section III is a plastic manifold that holds Braille cell pins labeled as IV in the figure.

FIG. 11 is a sectional view of another embodiment of electrothermal cylinders in the rest state according to the present invention that can be used in a refreshable tactile user interface cell.

FIG. 12 is a sectional view of another embodiment of electrothermal cylinders in the actuation state according to the present invention that can be used in a refreshable tactile user interface cell.

FIG. 13 is a sectional view of another embodiment of electrothermal cylinders in the raise state according to the present invention that can be used in a refreshable tactile user interface cell.

FIG. 14 is a sectional view of another embodiment of electrothermal cylinders in the fast refresh (cooling) state according to the present invention that can be used in a refreshable tactile user interface cell.

FIG. 15 is a schematic side view of an electronic device embodying the refreshable tactile user interface of the present invention.

FIG. 16 is a top plan view of the electronic device shown in FIG. 15.

FIG. 17 is a schematic cross-section view taken along the line A in FIG. 16 showing the refreshable tactile user interface of the present invention in a resting state.

FIG. 18 is a schematic side view of the electronic device presented in FIG. 15 showing the refreshable tactile user interface in an actuation state.

FIG. 19 is a top plan view of the electronic device shown in FIG. 18.

FIG. 20 is a schematic cross-section view taken along the line B in FIG. 19 showing the refreshable tactile user interface of the present invention in an actuation state.

### DETAILED DESCRIPTION OF THE INVENTION

The present invention provides tactile user interfaces, methods for actuating such interfaces and devices including such interfaces. The tactile user interfaces include refreshable cells that can transmit information to the user through touch (e.g., Braille). In general terms, refreshable cells (e.g., Braille cells) according to the present invention utilize cylinders that move in response to a medium that expands upon application of heat; they do not depend upon a piezoelectric motor.

Where the tactile user interface includes Braille cells, each one of the cylinders corresponds to one of the dots in a Braille cell. Typical Braille cells contain six or eight dots (cylinders) arrayed in two columns. Each cylinder either includes a medium that expands upon heating or is in contact with a second cell element that includes a medium that expands upon heating.

Where the cylinder includes an expandable medium, the cylinder further includes a mechanism for heating the medium and a flexible medium that deforms in response to the expanding medium. The deformed flexible medium forms a bump on the surface of the tactile user interface, with the bump serving as informational content (e.g., dot in a refreshable Braille cell) for the user.

Where the cylinder is in contact with a second element including the expandable medium, the second element comprises a mechanism for heating the medium. When the medium expands, the second element forces the cylinder to move; the top of the cylinder presses against the surface of the tactile user interface. This pressure forms a raised extrusion or bulge (e.g., dot).

A tactile user interface according to the present invention (e.g., Braille display) typically comprises a number of refreshable cells arranged in one or more rows. Such display systems can be used in any type of device that can be or is touched by the hand and can be made to communicate or display tacitly. The present invention is particularly adapted for use in computer displays and handheld electronic devices (e.g., phones) with the cells actuated under software control to communicate information through the cells. As further described below, however, the tactile user interface can be used in many different applications beyond computer displays and handheld electronic devices.

It will be understood that in describing the present invention, when an element or layer is referred to a being “on”, “connected to”, “coupled to” or “in contact with” another element or layer, it can be directly on, connected or coupled to, or in contact with the other element or layer or intervening elements or layers may be present. In contrast, when an element is referred to as being “directly on”, “directly connected to”, “directly coupled to” or “directly in contact with” another element or layer, there are no intervening elements or layers present. Likewise, when a first element or layer is referred to a being “in electrical contact with” or “electrically coupled to” a second element or layer, there is an electrical path that permits current flow between the first element or layer and the second element or layer. The electrical path may include capacitors, coupled inductors, and/or other elements that permit current flow even without direct contact between conductive elements.

It will also be understood that, although the terms first, second, etc. may be used herein to describe various elements, components regions, layers and/or sections, these elements, components, regions, layers and/or sections should not be limited by these terms. These terms are only used to distinguish one element, component, region, layer or section from another region, layer or section.

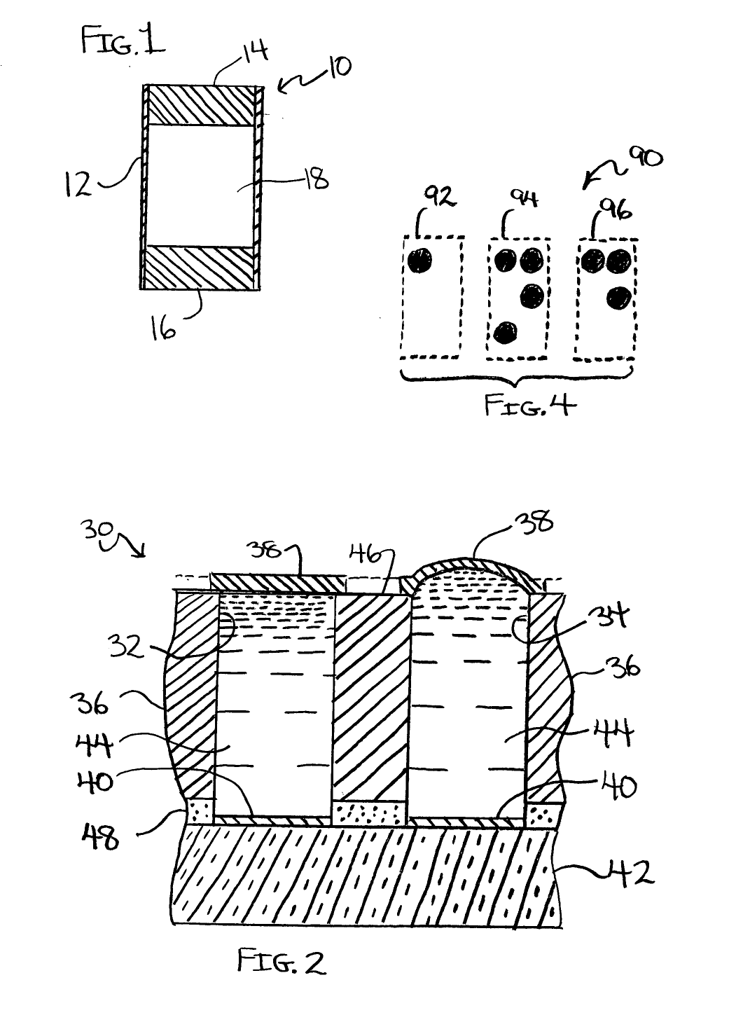

FIG. 1 shows a previously described cylinder 10 that can be used in a cell (e.g., Braille cell) according to the present invention and that can be combined with other similar cylinders (e.g., five or seven) to form a cell (e.g., Braille cell). See WO 2006/108121. The cylinder comprises a cylinder housing 12 and a flexible membrane 14 over one open end of the cylinder housing 12. The flexible membrane 14 forms one of the dots of the cell (e.g., Braille cell). The flexible membrane 14 can be made of many different materials but is preferably made of material having a low modulus of elasticity.

The cylinder 10 further comprises a heating mechanism 16, and in different embodiments the heating mechanism 16 can be arranged in many different locations on the inside or outside of the cylinder housing 12. As shown, the heating mechanism 16 is arranged in the opening of the cylinder housing 12 opposite the membrane 14. Many different heating mechanisms can be used, with a suitable heating mechanism 16 as shown being a microheater on a substrate. The heating mechanism 16 generates heat in response to an electrical signal, with the substrate containing structures, such as conductive traces, that conduct an electrical signal to the microheater.

The microheater may be similar to that described in the following publications that are hereby incorporated by reference: Grosjean et al., A Thermodynamic Microfluid System [Conference Paper], Technical Digest, MEMS 2002 IEEE International Conference, Fifteenth IEEE International Conference on Micro Electro Mechanical Systems (Cat. No. 02CH37266) IEEE 2002, pp. 24-27, Piscataway, N.J., USA; Grosjean et al., Micro Balloon Actuators For Aerodynamic Control [Conference Paper] Proceedings MEMS 98, IEEE Eleventh Annual International Workshop on MicroElectro Mechanical Systems, In Investigation of Micro Structures, Sensors, Actuators, Machines and Systems (Cat. No. 98CH36176), IEEE, 1998, pp. 166-71, New York, N.Y., USA; Goldschmidtboing F., Katus P., Geipel A., Woias P. 2008 A novel self-heating paraffin membrane micro-actuator in Proceedings of the IEEE International Conference on Micro Electro Mechanical Systems (MEMS), MEMS 2008 Tucson-21^{st} IEEE International Conference on Micro Electro Mechanical Systems, 2008, pp. 531-534; Lehto M., Boden R., Simu U., Hjort K., Thornell G., Schweitz J. 2008 A polymeric paraffin microactuator JMEMS 17 1172-1177; and, Lee J. S., Lucyszyn S. 2005 A Micromachined Refreshable Braille Cell JMEMS 14, 673-82.

The cylinder housing 12 is at least partially filled with a medium 16 that expands under heat, such as a gas or a liquid, although it is understood that different materials and different combinations of materials can be used. When an electrical signal is provided to the heating mechanism 16, it heats the medium causing it to expand within the cylinder housing 12. All surfaces of the cylinder 10 contacting the medium are rigid except for the flexible membrane 14, such that the expanding medium causes the membrane 14 to bulge. This bulge serves as an actuated extrusion on the surface of the tactile user interface (e.g., an actuated dot of the Braille cell).

When the electrical signal is removed from the heating mechanism 16, the medium 18 cools and contracts, and the membrane returns to its original position. The expansion 1 and contraction of the medium allows for cylinder 10 and its corresponding cell (e.g., Braille cell) to be “refreshed”. This expansion and contraction of the medium under an electrical signal that causes heat gives the cylinder 10 its electrothermal characteristics.

FIG. 2 shows first and second cylinders 32 and 34 of a previously described Braille cell 30 according to the present invention. See WO 2006/108121. The Braille cell also contains either an additional four or six cylinders, as the case may be, to form a complete Braille cell. Each of the cylinders is defined by a chamber wall 36, a membrane 38 and a microheater 40. The cylinders are arranged on a substrate 42 with each microheater 40 on the substrate at the base of the cylinder and the chamber walls 36 bonded to the substrate 42. The microheater generates heat in response to an electrical signal and is preferably an electrode deposited on the substrate using known deposition methods such as sputtering, E-beam evaporation, or lift-off methods.

In the lift-off method, lithography is used to provide a pattern that is the reverse of the electrode pattern. Namely, the areas of the substrate not to be covered by the electrodes are covered by a photoresist. After metal deposition, the photoresist is dissolved in an acetone bath, leaving the electrodes covering the desired areas of the substrate. This allows the electrodes to be formed in the desired pattern without post deposition etching steps. In other embodiments according to the present invention, the substrate can comprise a printed circuit board.

A fluid (medium) 44 at least partially fills each of the cylinders 32 and 34 with the fluid, preferably filling substantially all of the cylinders. Many different fluids can be used to fill the cylinders, 32 and 34, with preferred material being air or one or more phase change materials alone or in combination with other materials. A suitable phase change material is a paraffin wax that can include one or more paraffins. In the embodiment having a mixture of paraffins, the mixture can include n-paraffins, iso-paraffins and cycloparrafins, with n-paraffins typically being the predominant type. Paraffins used in the present invention can have a melting point range of approximately 10° C. or less. In certain cases, the melting point range is 5° C. or less, 4° C. or less, 3° C. or less or even 2° C. or less.

Paraffins used in the present invention typically begin melting above 35° C. Oftentimes they begin melting above 40° C., 50° C., 60° C., 70° C. or higher. The use of paraffins including greater than or equal to 90 percent of the same compound can be desirable. In some embodiments, use of paraffins including greater than or equal to 95 percent of the same compound or greater than or equal to 97 percent of the same compound is desirable. Paraffins used in the present invention may optionally include one or more antioxidants. A non-limiting list of such antioxidants includes: vitamin E; vitamin C; BHA; and, BHT. Typically, the antioxidants are included at a weight/weight percentage of 1 percent or less. The Paraffin wax embodiment can be injected into the cylinders in it liquid state using known injection methods.

Nonlimiting examples of other phase change materials that can be used to fill the cylinders 32 and 34 include: fatty acids (e.g., lauric acid); fatty esters; salt hydrates (e.g., Mn(NO₃)₂.6H₂0+MnCl₂.4H₂O (4 wt %) and Na₂SiO₃.5H₂O); organic compounds in water (e.g., trimethylolethane (63 wt %) and water (37 wt %)); and, eutectics.

The membrane 38 is shown with separate membrane sections covering the top openings of the cylinders 32 and 34. In other embodiments, the membrane can be one single piece covering the cylinder openings as well as the chamber wall mesas 46 shown in phantom. As described above, the membrane is preferably made of flexible material having a low Young's modulus such as commercially available silicone and BCB (Cyclotene from Dow Chemical). The membrane can be bonded in place over the cylinders using known bonding methods, such as spin coating.

The chamber wall and the substrate are preferably made of materials having low heat conductivity and are electrically insulating. Many different materials can be used such as glass, plastics, semiconductors and some ceramics. Silicon is also a suitable material in that microfabrication using silicon has been developed that can be applied to the present invention. In one embodiment using silicon, the chamber walls 36 are provided as a single wafer that can then be etched by DRIE (Bosch etch) to form the cylinder openings.

For glass, etching processes can also be used, although it may be difficult to form straight chamber walls etching from glass. Cylinders can be formed in plastic using known fabrication methods. In still other embodiments the chamber wall and substrate can be made of a polymer, such as polycarbonate or PMMA. Alternatively, a thick photoresist such as commercially available SU-8 can be used and photo-patterned to form the cylinders 32 and 34. It is understood that many different materials can be used, and the cylinders can be formed in the materials using many different methods.

Cylinders 32 and 34 can have many different diameters, with a suitable diameter being between 1.0 mm and 1.9 mm. Preferred cylinder diameters are between 1.4 and 1.6 mm, which corresponds to the common dot base diameters for English-based Braille cells. The cylinders can also have different depths, with one suitable depth being approximately 500 μm.

The substrate 42 can be made of many known materials, such as silicon, and can have conductive traces formed thereon using known methods. The traces conduct electrical signals to the electrodes (microheater) 40. The structure (wafer) forming the chamber walls 36 can be bonded to the substrate 42 by a bonding layer 48. The bonding layer can be a polymer adhesive, such as BCB® (Dow Chemical) or Overglaz (QQ 550, Dupont Company). If the chamber wall wafer and/or substrate are made of glass, they can be bonded together using fusion bonding. If either or both are made of a photoresist or plastic, direct bonding methods can be used. It should be understood that the bonding method depends on the type of material selected for the substrate and chamber walls.

As shown in FIG. 2, chamber 32 is not actuated. That is, its electrode 40 is not generating heat such that its fluid 44 is not expanding. Chamber 34, on the other hand, is actuated. Its electrode is being energized by an electrical signal to heat its fluid. This caused the fluid to expand and the membrane 38 to bulge over the cylinder opening. The desired membrane bulge is actuated by controlling which electrode is energized. The desired electrodes can be energized using known methods, with the electrodes 40 deposited on the substrate 42 with interconnecting traces to allow each electrode to be separately energized. This type of electrode and trace interconnection is known.

In the previously described Braille cell of FIG. 2, actuators have typically used varied substrates such as silicon and glass, typical materials used in MEMS. These materials have superior machining capacity and very small structures can easily be created using micromachining techniques. The dimensional requirements of the present system, however, are not severe, and high precision machining can be used instead of micromachining to fabricate the tactile user interfaces (e.g., Braille displays). Accordingly, the present invention typically uses PCB as the substrate and conventional PCB-based circuit manufacturing techniques to create phase-change-material based interfaces (e.g., Braille displays). Both rigid and flexible substrates can be used for this purpose.

Conventional PCB manufacturing techniques are used to pattern wires for heater connections and the heater itself. Machining techniques such as laser ablation and CNC routing are used to pattern wax chambers and coolant flow grooves in PCB.

This approach is cost effective, as it eliminates the use of the expensive micromachining processes such as photolithography, we and dry etching, and thin film deposition methods such as sputtering and E-beam evaporation. Another advantage of this technique is that small segments of PCB can be integrated to make large displays. The segments can be replaced if any Braille cells are damaged without the need to replace the entire display.

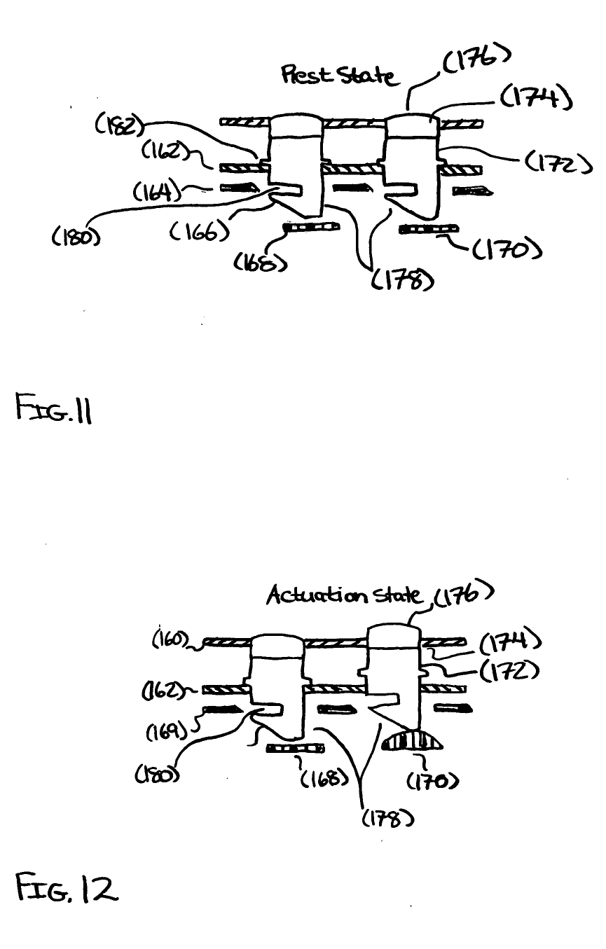

In the previously described design shown in FIG. 2, the phase-change-material based actuator requires considerable power to match the performance requirements for a satisfactory refreshable Braille cell (i.e., actuation height of 0.3 mm in less than 0.5 s). The present invention disclosed a structure and method that reduces such power/performance requirements by including pins within Chamber 34. See FIGS. 9 and 10.

Chamber 34 is divided into two separate sections. One section is wide with a thin-film heater at one end and contains most of the liquid medium (e.g., paraffin wax). The second section is very narrow (e.g., 0.3 mm diameter, height of the actuator) and is connected to the external pin (e.g., 1.5 mm diameter) as shown in FIG. 9. Primary reduction in the amount of required fluid medium (e.g., paraffin wax, thermal mass) is obtained by reducing the diameter of the second section by approximately 3-fold. The new geometrical configuration results in the reduction of the required wax amount from 4.29 mm³ down to 0.377 mm³ (greater than 10× reduction in overall volume for this example). This substantial reduction in liquid volume does not reduce the dimensions of the cell dots.

Inclusion of pins also imparts solidity to the touch screen. Even though expansion of wax can generate pressures of more than 20 MPa, it is still in the liquid state. Attachment of pins to the membrane covering the wax chamber provides a solid interface between the tactile interface (e.g., Braille screen) and the user.

Material for the pins should have a low density, low thermal conductivity, low heat capacity and low thermal expansion. In addition, pin material should be easy to machine and bond to the membrane covering the wax chamber. Also, the structural integrity and resistance to wear and tear are also very important characteristics in the pin material. Polymeric material generally provides these desired characteristics and is accordingly suitable for this purpose.

The pins of the present invention may be centrally hollowed with ridges, grooves or textured surfaces on the outside along their vertical length (FIG. 10), although this is not necessary. The top of the pins may also have small ridges. Such texture improves the interaction between user and display in that one can further differentiate between pins and, in turn, the informational characters (e.g., Braille characters).

A manifold made of material such as Ultem is typically used to hold the pins intact (FIG. 10). CNC machining is used to create holes that allow the pins to snuggly fit inside the holes and prevent any lateral movement of the pins. Pins are connected rigidly to the membrane using silicone based glue, or similar methods to transmit the actuation movement without any losses.

The locking mechanism (FIG. 11) can be used for such an application. The pins will be partially raised by the expansion of the paraffin underneath (FIG. 12). The partially actuated/raised pins will be locked using the friction force of the mechanical pin that uses a linear motor to induce the motion of the locking mechanism.

The locking mechanism can essentially be made of two plates that prevent the tilting of the pins being actuated. The third plate is used as the lock that moves in a direction perpendicular to the pin actuation and fits in the grooves of the pins one desires to actuate. The pins corresponding to Braille dots that need to be actuated will be raised to 0.1 mm. At that point, the locking mechanism will be activated and partially raised pins will be engaged or locked in a fixed position. These locked pins will be raised to the final actuation height (greater than 0.33 mm) by a linear motor acting in the direction of actuation. Use of a single motor to complete the actuation motion will substantially reduce the overall power requirements. Both actuation and retraction times will be comparable or better than piezo-based systems, as the phase-change (e.g., paraffin-based) based actuator is only required to actuate to 0.1 mm. In certain cases, the actuation and retraction times are more than 5% faster than a similar piezo-based system; in other cases they are more than 10%, 15% or 20% faster.

One may use multiple actuators per Braille dot according to the present invention. For example, six actuators of 0.15 mm diameter fit beneath a Braille pin of 1.5 mm diameter. The multiple actuators can be sequentially operated to reduce the effect of fatigue on an individual actuator and increase the shelf life of a tactile display.

The present invention employing a phase change-based actuation technology may be used in a variety of electronic devices such as portable communication and computing apparatuses. Nonlimiting examples of electronic devices that may include the present invention are: phones; PDSs; airport kiosks; touch screen computers; ATMs; mobile devices; navigation devices; refreshable Braille displays; and tactile computer screens. The technology will impart “tactile buttons” on a keyless interface for such a device. When activated—for example by the user of by an external signal such as an incoming call as described by U.S. Pat. Appl. 20080010593—a button will appear on an otherwise flat touchscreen or surface. Others have attempted the use of piezo-based technology for similar applications, but piezo-based actuators are expensive to manufacture and difficult to miniaturize to fit in a small scale device. Accordingly, the present invention may be used in virtually any electronic device and is not limited to the visually impaired community.

Heating of the fluid medium (e.g., paraffin wax) typically results in heat gradients within the medium. If local temperatures near the actuator are not controlled properly, this will result in evaporation of the fluid medium. Such evaporation my produce an non-functional actuator, as the medium can be lost through membrane permeation. One can prevent that situation from occurring by controlling both local actuator and global temperatures within the medium. The two different temperature types can be managed in several ways; two non-limiting examples include: (i) programming cyclical power for the actuator; and, (ii) creating grooves in the substrate for coolant to flow.

The amplitude and frequency of power used to heat the actuator is based on the required actuation time and melting range of the wax being used. The flow rate and temperature of the coolant is also programmed accordingly. Optimization of the relevant operational parameters is done to minimize the over-cooling of the system. The presence of grooves with air-gaps also increases the insulation between neighboring dots and reduces the potential cross-talk between them.

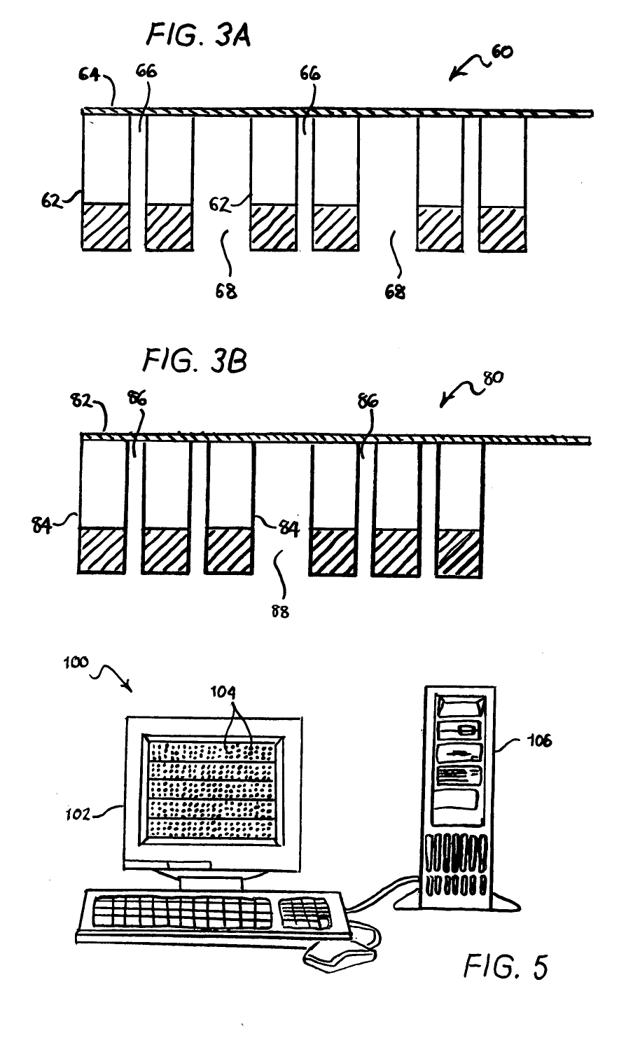

FIG. 3a shows a sectional view of one of three Braille cells 60. Each Braille cell typically comprises six (6) cylinders 62, although only two cylinders in each cell are shown. A continuous membrane 64 covers the cylinders. Within each cell, space 66 between cylinders 62 as shown is typically between 2.03 and 3.25 mm, although other spaces can also be used. Preferred horizontal spaces within a cell are between 2.2 and 2.54 mm. The space between adjacent Braille cells in a line 68 is typically between 2.5 mm and 6.53 mm, with the preferred space between cells being between 3.81 mm and 5.42 mm.

FIG. 3b shows a sectional view of one embodiment of two Braille cells 80 that are arranged in two different lines. A continuous membrane 82 covers the cylinders 84. Spaces 86 between the dots within a Braille cell are approximately the same dimensions as spaces 66 in FIG. 3a. The space 88 between adjacent Braille cells is approximately the same dimension as spaces 68 in FIG. 3a.

FIG. 4 shows one embodiment of three Braille cells 90, 92, 94 having cylinders that have been actuated to bulge the desired membrane. One dot (bulged membrane) appears in cell 92, which corresponds to the letter “a”; four dots appear in cell 94, which correspond to the letter “n”; and, three dots appear in cell 96, which correspond to the letter “d”. The combination of the three Braille cells forms the word “and”. Each of the Braille cells can be refreshed and form the dots to a different letter by removing the energy from the cylinders and then energizing the desired cylinders to form the desired dot pattern.

FIG. 11 shows a pin design for inclusion in a tactile user interface of the present invention. As pictured, two pins (178) are in the rest state and are in contact with a top surface or membrane 160. Pins 178 include six different sections: a top (176), which is typically curved, textured plastic; a proximal portion connected to the top (174), which is also typically made of plastic; a distal portion (172) connected to the proximal portion, which is typically made of metal; a notch or groove (180) that is in distal portion 172; an incline subsection (166), which is part of distal portion 172 and participates in the raising and locking of pins 178; and protrusion 182, which contacts locking layer 162, locking pins 178 at a minimum height.

FIG. 12 shows the same pin design as FIG. 11, although an actuation state is depicted. In the actuation state, actuator 168 increases in volume in response to heating, thereby providing pressure on distal portion 172. The pressure forces pin top 176 through surface 160.

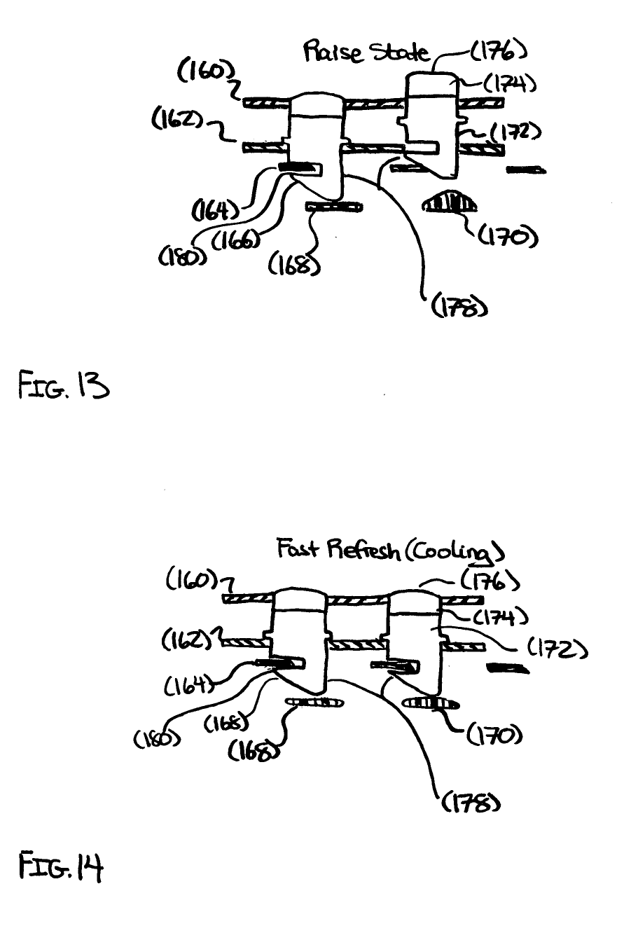

FIG. 13 shows the same pin design as FIGS. 11 and 12, but a raised state is depicted. In this state, actuator 168 pushes a pin to its maximum height. Locking mechanism 164 contacts incline subsection 166 and holds the pin at that height. This effectively provides a tacitly observable dot on surface 160.

FIG. 14 shows the same pin design as FIGS. 11, 12 and 13, but pins 178 are depicted in a fast refresh or cooling state. Actuator 168 reduces in volume as it is no longer heated. This results in the lowering of the pin, which no longer presents as a tacitly observable dot.

FIG. 5 shows one embodiment of computer display system 100 utilizing refreshable Braille cells. The system 100 comprises a computer display 102 having multiple refreshable Braille cells 104 arranged in the desired rows to allow the user to touch the surface of the cells 104. The display 102 is coupled to controller 106 that provides the necessary electrical signals to cause the desired dots (membrane bulges) to form at the Braille cells 104. The controller 106 can be many different devices, such as a known personal computer (PC).

The Braille cell control signals transmitted to the computer display 102 can be generated using different software approaches. One is to have an operating system on the controller specifically designed to generate the Braille cell control signals. This can include known Windows, Linux or Macintosh operating systems on a PC, or independently developed operating systems on a PC or other platform. Another approach would allow the existing operating system such as Windows or Linux, Macintosh, or other operating system to work with translation software that translates the typical visual output to binary or Braille cell output. This allows a standard Windows screen to be translated so that only the outline of Windows and an outline of its Icons would be displayed with Braille text instead of Ascii test. For both software approaches, signals would be sent to individual cells to control which dots are actuated.

Braille cells according to the present invention can be used in many applications beyond computer displays. For example, cells can be used on the steering wheel of an automobile that has the points raised to cue the driver of an emergency. The cell could be used on a hand-held device carried by military, firefighters or whoever may be working in a zero-visibility environment. Any kind of device that can be touched by the hand can be made to communicate or display tacitly.

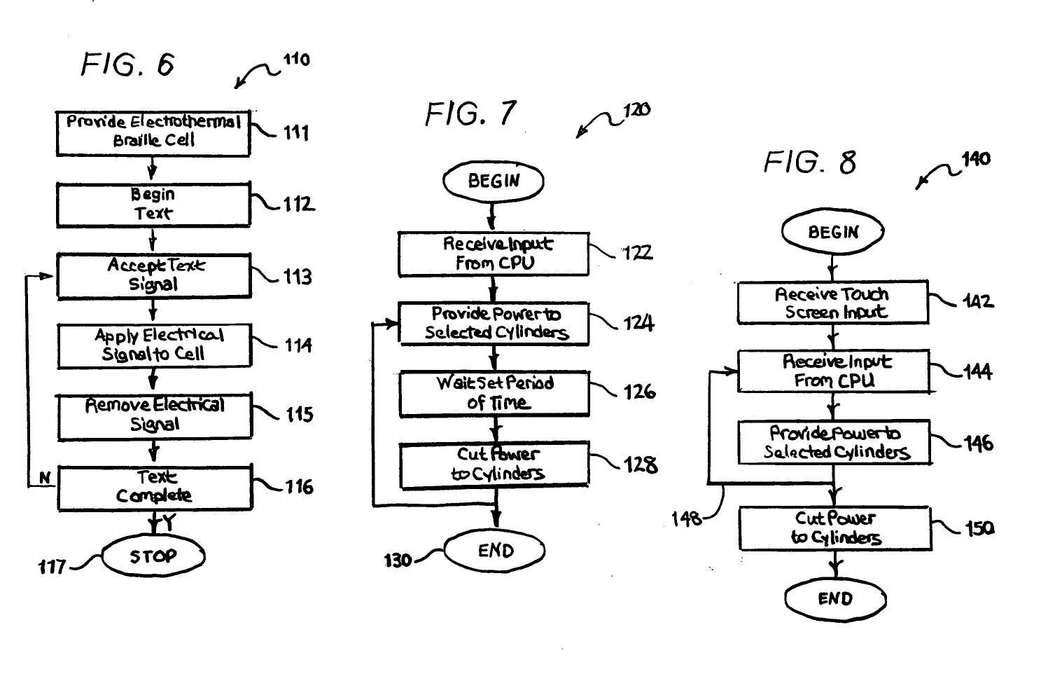

FIG. 6 shows one embodiment of a method 110 for forming Braille characters in a Braille cell according to the present invention. Although method 110 is described in a series of steps, it is understood that the method steps can be in different order and can have different steps. In step 111, an electrothermal activated Braille cell is provided, and in a preferred method the Braille cell comprises cylinders having a medium that expands under heat, a microheater, and a membrane similar to those shown in the figures and described above.

In step 112, text begins that is to be displayed by the Braille cell. In step 113, a signal (message) is accepted having the information to activate the desired ones of the Braille dots in the Braille cell. This signal can originate from the operating system of a PC as described above. In step 114, an electrical signal is applied to the desired ones of the Braille dots to be activated. This causes the microheater to heat the medium within the particular cylinder, which in turn causes the membrane to bulge forming a raised dot. In step 115, after a predetermined amount of time, the electrical signal is removed from the Braille cell, causing the medium to cool and contract and causing the membrane to return to its original position over the cylinder. This is the refresh state of the Braille cell.

In step 116, if the text that is to be displayed is complete, the method stops (117). If, however, there is more text to be displayed, the method returns to step 113 and accepts another signal for displaying another character. This continues until the text is complete.

FIG. 7 shows another embodiment of a method 120 for using the present invention in a refreshable tactile user interface (e.g., Braille display), and although this method is described in a series of steps, it is understood that the method steps can be in different order and can have different steps. Input is received from a CPU in step 122, and power is provided to select cylinders or pins that correspond with the input at step 124. A set period of time is allowed to pass in step 126, and power is then cut to the cylinders in 128. This either signals the end of the display material 130 or the need to begin the process again.

In certain cases, the refreshable tactile user interface of the present invention includes a touch screen where the interface cells are activated only in the area touched by the user's fingers. This can include the cells directly under the fingers or in areas under and around the fingers. The touch screen can be part of membrane 64 described above and shown in FIG. 3a or can comprise a material layered on top of membrane 64. Different touch screen systems and methods can be used according to the present invention, including but not limited to, capacitive-based, resistive-based, infrared-based and surface acoustic wave-based systems and methods. See, for example, U.S. Pat. No. 6,741,237, which is hereby incorporated-by-reference.

According to the present invention, preferred methods for touch activating a screen involve techniques based on change in electrical resistance (e.g., strain gauge). To impart touch sensitivity using a strain gauge, the gauge is patterned on the top of the pins using evaporation or sputtering of an electrically conductive material. The change in resistance of this strain gauge by external force, such as caused by touch, is used to decide exactly what part of the screen is being accessed by the user. Either wireless or electrical connection-based external interface can be used for thermocouples and strain gauges.

Temperature monitoring of the screen or particular portions of the screen can be accomplished using any suitable method. One such method involves a thermocouple. To create a thermocouple, an electrical wire is patterned around each Chamber 34 and change in resistance across the wire is calibrated to the temperature. The feedback from the thermocouple reading is used to control the power to the corresponding heaters.

A 3-dimensional topography of the screen should be used for the image or map display where optimal performance is desired. The Braille pins can be raised and maintained to different heights by programming an input power accordingly. This type of topography is quite important in case of GPS-based navigational tools for the visually impaired.

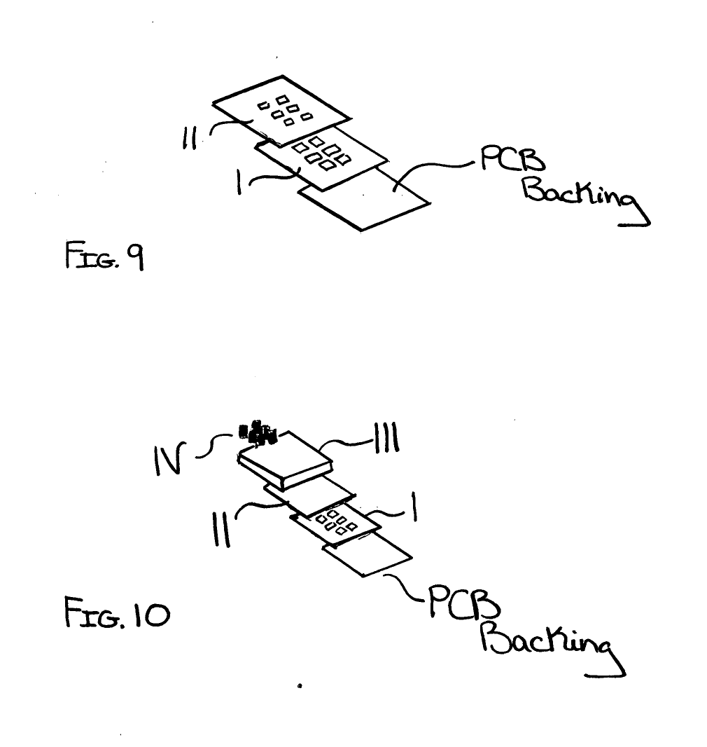

FIG. 8 shows one embodiment of method 140 for using the touch screen version of the present invention. As the result of a person's touch, input is received by the CPU 142. The input includes the location of the person's touch on the screen, as well as the area of the touch. After receiving the input, the CPU correlates it with information related to display content; further input is sent by the CPU 144, and power is provided to select cylinders/pins that correspond with the input 146. Power is provided until the person moves his finger from its original location on the touch screen. If the finger glides along the surface of the touch screen, it will induce power to be provided to other, select cylinders 148 while cutting power to the originally activated cylinders 150. If the finger is removed from the surface of the touch screen, power to the cylinders will simply be cut 152.

The number of cylinders/pins receiving power as the result of a single touch varies. Typically, at least the number of cylinders associated with a single character (e.g., a single Braille cell) will be activated. In certain cases, cylinders associated with multiple characters (e.g., 2, 3, 4 or 5 cells) will be activated. The activated cylinders, or cells, typically relate to the same line of text on the display.

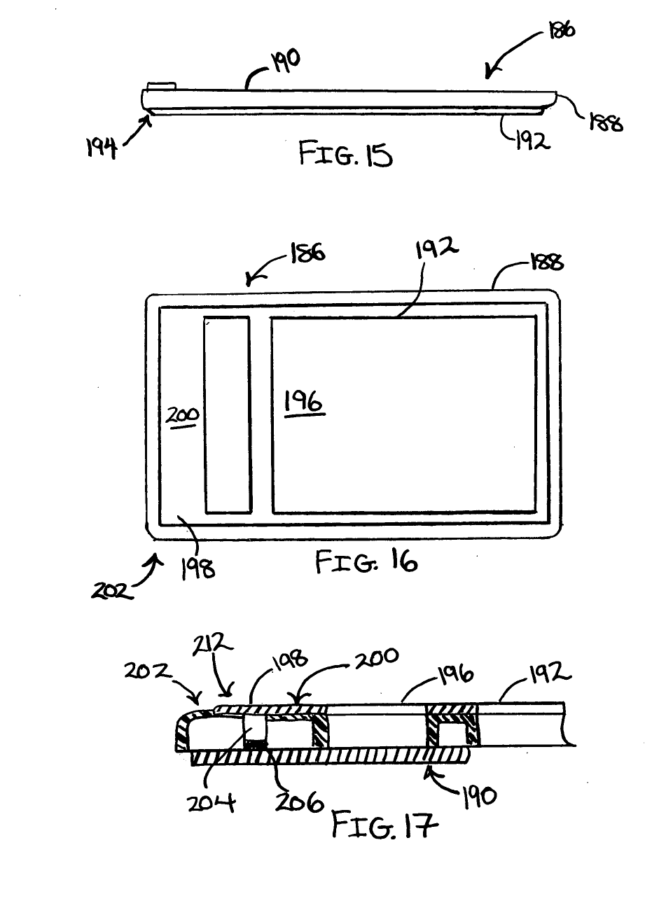

FIGS. 15-17 show an electronic device (186, e.g., mobile telephone) embodying the refreshable tactile user interface of the present invention. Only the cover portion generally designated 188 of the electronic device 186 is illustrated for purposes of explanation. The electronic device 186 includes a printed circuit board 190 suitably arranged and carried in the cover 188. An elastomer/rigid two component plastic part keypad generally designated 192 is suitably arranged and carried on an outward facing side 194 of the cover 188. The keypad 192 includes an elastomer portion 198 whose outward facing surface 200 is substantially flush with the surface 196 of the keypad 192. The refreshable tactile user interface embodying the present invention is generally designated 212 and is located at one end 202 of the electronic device 186 in the region of the elastomeric portion 198 of the keypad 192. The elastomeric portion 198 includes the cylinder of FIG. 2 (although it should be recognized that the pin system of FIGS. 11-14 can also be substituted into the figure), with a medium-filled cylinder 204 and heat-based actuator 206 shown. As illustrated in FIGS. 15-17, the keys defined by the elastomer portion 198 are not accessible and available for use.

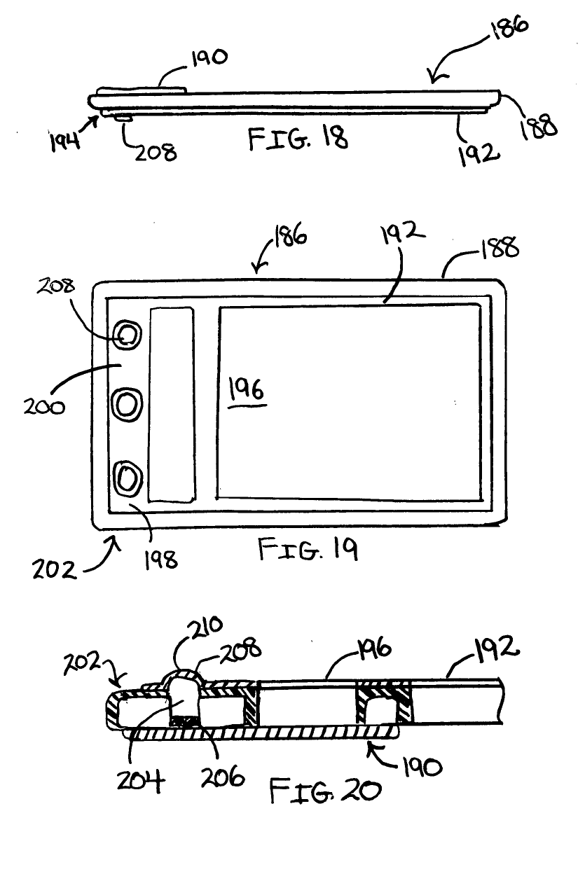

FIGS. 18-20 show the electronic device 186 as in FIGS. 15-17, where the refreshable tactile user interface embodying the present invention is activated to make a key or button 208 available for access and use by causing the topography of the contact surface area 210 to bulge or project above the surface topography 200 of the user interface or keypad 192. In this situation, cylinder 204 has expanded in response to heat provided by actuator 206.

Although the present invention has been described in considerable detail with reference to certain preferred configurations thereof, other versions are possible. Therefore, the spirit and scope of the appended claims should not be limited to their preferred versions contained therein.

1. A method for actuating a Braille cell, comprising: providing power to a microheater within a cylinder, wherein the cylinder has a membrane at one end, and a heat expandable medium and further wherein the cylinder is divided into two separate sections, a first section and a second section; heating said heat expandable medium with said microheater, thereby causing it to expand; and bulging out said membrane under pressure from said expanding heat expandable medium, thereby forming a dot.

2. The method according to claim 1, wherein the first cylinder section contains most of the heat expandable medium, and the second cylinder section is connected to an external pin.

3. The method according to claim 2, wherein the external pin comprises polymeric material.

4. The method according to claim 2, wherein the external pin is centrally hollowed.

5. The method according to claim 4, wherein the external pin furthermore has ridges, grooves or textured surfaces on the outside along its vertical length.

6. The method according to claim 5, wherein the top of the external pin has ridges.

7. The method according to claim 6, wherein the external pin comprises polymeric material.

8. The method according to claim 7, wherein there are a plurality of cylinders within a substrate, and a manifold is used to hold the plurality of external pins within the plurality of cylinders intact.

9. The method according to claim 8, wherein there are grooves in the substrate that allow coolant flow.

10. A refreshable Braille display comprising: a plurality of Braille cells arranged allow the user to touch the surface of the cells, each of said Braille cells comprising: a plurality of cylinder housings; a flexible membrane covering the openings at one end of the cylinder housings; and a mechanism for causing the flexible membrane at said respective one of said cylinders to bulge out to form a Braille dot; wherein the display is made using steps comprising conventional printed circuit board-based circuit manufacturing techniques.

11. The display according to claim 10, wherein the display comprises small segments of printed circuit board that are integrated to form the display.

12. The display according to claim 11, wherein the small segments of printed circuit board are individually removable and replaceable.

13. The display according to claim 12, wherein the Braille cells are activated in the area touched, and the area immediately around the touched area, by one or more of a user's fingers, and wherein touch screen is based on a change in electrical resistance, and wherein the change of electrical resistance is measured by a train gauge.

14. The display according to claim 12, wherein the display is used for an image, symbol, graphic or map display, and wherein Braille pins are raised and maintained at various heights.

15. The display according to claim 12, wherein a manifold is used to lock the actuated pins in place.

16. The display according to claim 12, wherein it is incorporated into a GPS-based navigational tool for the visually impaired.

17. The display according to claim 12, wherein it is incorporated into a phone, PDA or mobile device for visually impaired or non-visually impaired persons.

18. The display according to claim 12, wherein it is incorporated into a touch screen computer or touch screen display for visually impaired or non-visually impaired persons.

19. The display according to claim 12, wherein it is incorporated into an airport kiosk for visually impaired or non-visually impaired persons.

20. The display according to claim 12, wherein it is incorporated into an ATM machine for visually impaired or non-visually impaired persons.

21. The display according to claim 12, wherein it is incorporated into an elevator display or control device for visually impaired or non-visually impaired persons.

22. An apparatus comprising: an input having a surface area configured for altering its surface topology characteristic in accordance with a given function of an electronic device for providing a haptic operative input corresponding to said given function, wherein there is a mechanism for altering surface topology of the surface area, and wherein the mechanism does not comprise a piezoelectric motor.

23. An apparatus comprising: an input having a surface area configured for altering its surface topology characteristic in accordance with a given function of an electronic device for providing a haptic operative input corresponding to said given function, wherein there is a mechanism for altering surface topology of the surface area, and wherein the mechanism comprises a cylinder or pin that moves in response to a medium that expands upon application of heat.

24. The apparatus according to claim 23, wherein said input surface area is arranged in a deformable portion of a surface of a suitable substrate.

25. The apparatus according to claim 24, wherein said input device is further configured such that said input surface area topology is flush with said surface of said substrate for indicating an unavailable operative input state and protrudes from said surface of said substrate for indicating an available operative input state.

26. The apparatus according to claim 24, wherein said deformable portion of said substrate is made of a suitable elastomer material.

27. The apparatus according to claim 26 wherein the surface altering mechanism is in co-operative engagement with said contact surface area for protruding said contact surface area from said substrate surface for haptic recognition of the presence of said input and for allowing said contact surface area to retract from said substrate surface for haptic recognition of the absence of said input.

28. The apparatus according to claim 22 further comprising a plurality of inputs, a first number of which are selectively enabled in accordance with a given operative mode of said electronic device and another number of which are selectively enabled in accordance with another given operative mode of said electronic device.

29. The apparatus according to claim 22, wherein said input surface area is further configured for providing a variable pressure haptic operative input such that a higher pressing force corresponds to an alert to respond to a condition of said given function of said input.

30. An input module comprising:
a substrate having at least one defined contact surface in a deformable portion of said substrate, and
an actuator mechanism suitably arranged and configured for altering the surface topology of said substrate at said at least one defined contact surface area,
wherein the mechanism comprises a cylinder or pin that moves in response to a medium that expands upon application of heat.

31. The input module according to claim 30, wherein said deformable portion of said substrate is a suitable elastomer material.

32. The input module according to claim 30, wherein said surface topology of said substrate at said at least one defined contact surface area protrudes beyond the surface topology of said substrate defining an input key.

33. The input module as defined in claim 30, wherein said actuator mechanism does not comprise a piezoelectric motor arranged for imparting a driving force against said substrate at said at least one defined contact surface area.

34. The display according to claim 11, wherein pins can be raised and lowered at multiple varied heights.
